(19) United States
(12) Patent Application Publication
(10) Pub. No.: US 2012/0198401 A1
(43) Pub. Date: Aug. 2, 2012

(54) APPARATUS AND METHOD OF SUPPORTING DESIGN OF SEMICONDUCTOR DEVICE

(75) Inventors: Yukihiro OKANO, Kanagawa (JP); Yasuo Sasaki, Kanagawa (JP)

(73) Assignee: Renesas Electronics Corporation

(21) Appl. No.: 13/360,246

(22) Filed: Jan. 27, 2012

(30) Foreign Application Priority Data
Jan. 31, 2011 (JP) 2011-018188

(51) Int. Cl. G06F 17/50

(52) U.S. Cl. 716/109

(57) ABSTRACT

A design supporting apparatus for a semiconductor device, includes an IR drop analyzing section configured to carry out an IR drop analysis on each of N (2 N) functional blocks, which operates independently on a semiconductor device, to generate an IR drop analysis result. An area of the semiconductor device is divided into small areas in a lattice. A mapping value generating section calculates a distribution of individual mapping values related to the small areas from the IR drop analysis result for each of the function blocks. A grouping section calculates a distribution of group mapping values from the distributions of individual mapping values for n (n≦N) simultaneously operating functional blocks of the N functional blocks, and output group data indicative of the n simultaneously operating functional blocks when each of the group mapping values falls within a permission value.

### CROSS REFERENCE

This patent application claims a priority on convention based on Japanese Patent Application No. JP 2011-18188. The disclosure thereof is incorporated herein by reference.

### TECHNICAL FIELD

The present invention is related to a design supporting apparatus for a semiconductor device and, for example, a technique for preventing a malfunction of a semiconductor device due to an IR drop.

### BACKGROUND ART

Recent years, functional blocks in a wider area than in an actual operation can be operated simultaneously at a test step of a semiconductor device through the miniaturization of a transistor. However, power supply wirings in the semiconductor device are designed based on the actual operation assumed after product delivery. In this way, such a test method can improve test efficiency but there is a case that the semiconductor device malfunctions due to IR drop generated in the test. This is because an external power supply voltage falls below the minimum operation guarantee voltage of the functional block of the semiconductor device. In such a case, a semiconductor device test apparatus determines a product of good quality to be defective, which results in reduction of a yield.

As the technique of a semiconductor device design supporting apparatus, JP 2006-066825A (Patent Literature 1) discloses the technique in which scan flip-flops are grouped based on an IR drop analysis result and a power supply RC network analysis result such that a malfunction due to the IR drop does not occur even if the scan flip-flops are scan-tested at a same time. Thus, in this technique, when it is determined that the malfunction of the semiconductor device has occurred due to the IR drop, the flip-flops are grouped once again, and IR drop analysis is carried out. Because the IR drop analysis is repeated until a group of the flip-flops is determined which can operate simultaneously, the increase of design TAT (Turn Around Time) by the design supporting apparatus is caused.

Citation List:

[Patent Literature 1]: JP 2006-066825A

### SUMMARY OF THE INVENTION

A design supporting apparatus for a semiconductor device is needed which can generate a test pattern such that the semiconductor device does not malfunction at the time of test, even if the functional blocks of the semiconductor device operate simultaneously in a wider area than in an actual operation. Also, the design supporting apparatus for the semiconductor device is needed in which the number of times of IR drop analysis is suppressed and the design TAT is reduced.

A design supporting apparatus for a semiconductor device, includes an IR drop analyzing section configured to carry out an IR drop analysis on each of N (2 N) functional blocks, which operates independently on a semiconductor device, to generate an IR drop analysis result. An area of the semiconductor device is divided into small areas in a lattice. A mapping value generating section calculates a distribution of individual mapping values related to the small areas from the IR drop analysis result for each of the function blocks. A grouping section calculates a distribution of group mapping values from the distributions of individual mapping values for n (n≦N) simultaneously operating functional blocks of the N functional blocks, and output group data indicative of the n simultaneously operating functional blocks when each of the group mapping values falls within a permission value.

A design supporting method, executed by a computer, for a semiconductor device, is achieved by carrying out an IR drop analysis on each of N (2 N) functional blocks, which operates independently on a semiconductor device, to generate an IR drop analysis result, wherein an area of the semiconductor device is divided into small areas in a lattice; by calculating a distribution of individual mapping values related to the small areas from the IR drop analysis result for each of the function blocks; by calculating a distribution of group mapping values from the distributions of individual mapping values for n (n≦N) simultaneously operating functional blocks of the N functional blocks; and by generating group data indicative of the n simultaneously operating functional blocks when each of the group mapping values falls within a permission value.

A non-transitory computer-readable storage medium which stores a computer-executable program code to attain a design supporting method for a semiconductor device. The design supporting method is achieved by carrying out an IR drop analysis on each of N (2 N) functional blocks, which operates independently on a semiconductor device, to generate an IR drop analysis result, wherein an area of the semiconductor device is divided into small areas in a lattice; by calculating a distribution of individual mapping values related to the small areas from the IR drop analysis result for each of the function blocks; by calculating a distribution of group mapping values from the distributions of individual mapping values for n (n≦N) simultaneously operating functional blocks of the N functional blocks; and by generating group data indicative of the n simultaneously operating functional blocks when each of the group mapping values falls within a permission value.

According to the present invention, the design supporting apparatus for the semiconductor device is needed which can generate the test pattern such that the semiconductor device does not malfunction at the time of test, even if the functional blocks of the semiconductor device operate simultaneously in the wider area than in the actual operation. Also, the design supporting apparatus for the semiconductor device is needed in which the number of times of IR drop analysis is suppressed and the design TAT is reduced.

### BRIEF DESCRIPTION OF THE DRAWINGS

FIG. 1 is a functional block diagram showing a configuration of a design supporting apparatus 20 according to a first embodiment of the present invention;

FIG. 2 is a flow chart showing a method of generating group data 14 by the design supporting apparatus 20 in the first embodiment;

FIG. 3A is a diagram showing functional blocks Grp1 to Grp5 existing on a semiconductor device and the functional block Grp1 operating independently or individually;

FIG. 3B is a diagram showing a distribution of individual mapping values 11 determined from an IR drop analysis result 9;

FIG. 4A is a diagram showing a method of calculating a distribution of individual mapping values 11 of two simultaneously operating functional blocks in the first embodiment;

FIG. 4B is a diagram showing the method of calculating another distribution of individual mapping values 11 of the two simultaneously operating functional blocks in the first embodiment;

FIG. 4C is a diagram showing the method of calculating a distribution of group mapping values 11 of the two simultaneously operating functional blocks in the first embodiment;

FIG. 5A is a diagram showing five simultaneously operating functional blocks Grp1 to Grp5 existing on a semiconductor device in a second embodiment;

FIG. 5B is a diagram showing a distribution of group mapping values of the five simultaneously operating functional blocks Grp1 to Grp5 on the semiconductor device in the second embodiment;

FIG. 6A is a diagram showing the four simultaneously operating functional blocks Grp1 to Grp3 and Grp5 on the semiconductor device in the second embodiment;

FIG. 6B is a diagram showing a distribution of group mapping values of the four simultaneously operating functional blocks Grp1 to Grp3 and Grp5 on the semiconductor device in the second embodiment;

FIG. 7A is a diagram showing the three simultaneously operating functional blocks Grp1 to Grp3 on the semiconductor device in the second embodiment;

FIG. 7B is a diagram showing a distribution of group mapping values of the three simultaneously operating functional blocks Grp1 to Grp3 on the semiconductor device in the second embodiment; and

FIG. 8 is a diagram showing a hardware configuration of the design supporting apparatus 20 for the semiconductor device.

### DESCRIPTION OF EMBODIMENTS

Hereinafter, a design supporting apparatus 20 for a semiconductor device according to embodiments will be described in detail with reference to the attached drawings.

### First Embodiment

(Configuration)

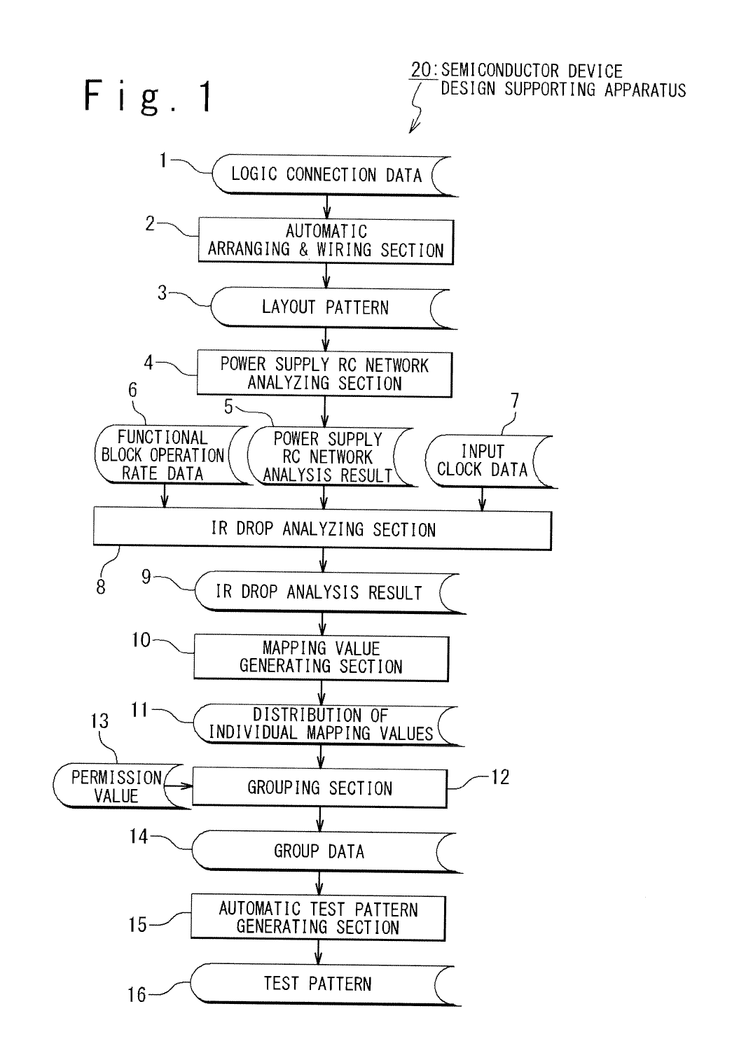

First, the configuration of the design supporting apparatus 20 for the semiconductor device in a first embodiment will be described. FIG. 1 is a functional block diagram showing the configuration of the design supporting apparatus 20 in the first embodiment. The design supporting apparatus 20 in the present embodiment is provided with an automatic arranging and wiring section 2, a power supply RC network analyzing section 4, an IR drop analyzing section 8, a mapping value generating section 10, a grouping section 12, and an automatic test pattern generating section 15.

The automatic arranging and wiring section 2 receives logic connection data 1 and outputs a layout pattern 3. The logic connection data 1 contains a gate description (logic data), and the number of gates, and is used to calculate a consumed power amount. A layout pattern 3 contains data of arrangement of semiconductor elements, cells, and functional blocks, and wirings, which configures the semiconductor device.

The power supply RC network analyzing section 4 receives the layout pattern 3 and outputs a power supply RC network analysis result 5. The power supply RC network analysis result 5 contains data indicative of a physical shape (wiring widths) of a power supply network and power supply distribution data such as distances from power supply sources.

The IR drop analyzing section 8 receives the power supply RC network analysis result 5, functional block operation rate data 6, and input clock data 7, and outputs an IR drop analysis result 9 when the respective functional blocks of the semiconductor device operate independently or individually, as an IR drop analysis result. The functional block operation rate data 6 is data indicative of an operation rate of each of the functional blocks, such as a toggle rate. The input clock data 7 is data indicative of a clock signal in the semiconductor device. The IR drop analysis result 9 is data indicative of the IR drop quantity being a function of a position and having a continuous spreading on the area of the semiconductor device.

The mapping value generating section 10 receives the IR drop analysis result 9 and outputs a distribution of individual mapping values 11. The individual mapping value 11 is generated by relating an IR drop quantity shown by the IR drop analysis result 9 to each of small areas when the area of the semiconductor device is divided into the small areas in a lattice shape, that is, by quantizing the IR drop analysis result 9. For example, the individual matching value has a maximum IR drop quantity in the small area. In this case, the individual mapping value contains data of the position of the small area on the semiconductor device and the maximum IR drop quantity in the small area.

The grouping section 12 calculates a group matching value obtained by adding the individual matching values corresponding to each of the small areas when functional blocks operate simultaneously. If the group matching value is smaller than a permission value 13, data obtained by grouping the simultaneously operable functional blocks is outputted as group data 14.

The automatic test pattern generating section 15 receives the group data 14 and outputs a test pattern 16. The test pattern 16 is generated based on the group data 14 and is used to test the functional blocks of the semiconductor device.

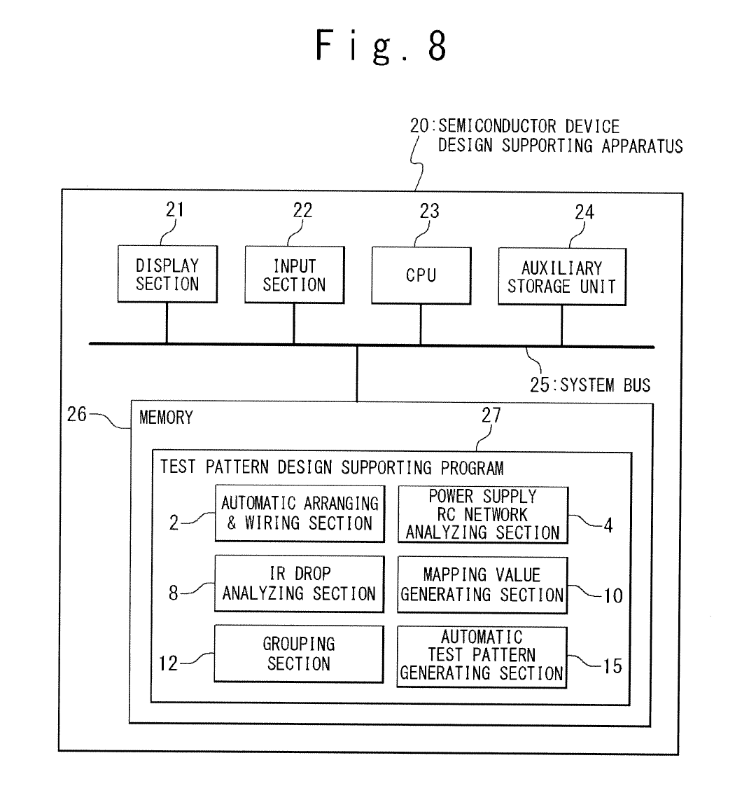

Next, the hardware configuration of the design supporting apparatus 20 for a semiconductor device in the present embodiment will be described. FIG. 8 is a block diagram showing a hardware configuration of the design supporting apparatus 20 in the present embodiment.

The design supporting apparatus 20 is provided with a display section 21, an input section 22, a CPU 23 (Central Processing Unit), an auxiliary storage unit 24, a system bus 25, and a memory 26.

The memory 26 is a main memory of the design supporting apparatus 20. In the design supporting apparatus 20, a test supporting program 27 which is used to realize the design supporting apparatus 20 of the present embodiment, is developed on the memory 26. The display section 21 displays an execution result of the design supporting apparatus 20. The input section 22 is an interface for the user to operate the design supporting apparatus 20. The CPU 23 executes the test supporting program 27 on an OS (Operating System). The auxiliary memory 24 stores the OS and the test supporting program 27 loaded from a storage medium (not shown). The system bus 25 is a communication path which connects the display section 21, the input section 22, the CPU 23, the auxiliary memory 24, and the memory 26.

(Operation)

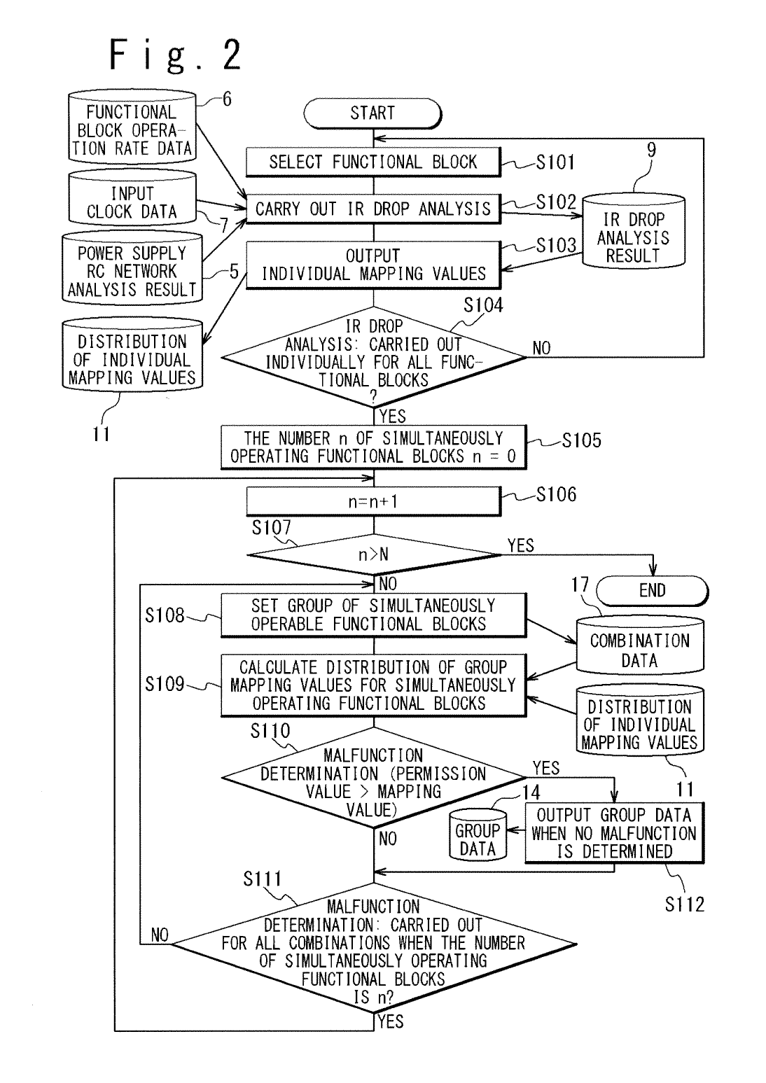

Next, a test supporting method by the design supporting apparatus 20 of the present embodiment will be described. The whole flow of the test supporting method by the design supporting apparatus 20 of the present embodiment is shown in FIG. 1. A method of generating the group data 14 in the present embodiment will be described in detail. FIG. 2 is a flow chart of the method of generating the group data 14 by the design supporting apparatus 20 in the present embodiment.

(Step S101)

The IR drop analyzing section 8 selects one of the functional blocks of the semiconductor device to be subjected to the IR drop analysis. The selected functional block has an input signal and an output signal which are independent from the other functional blocks in the semiconductor device and which can operate independently or individually in accordance with the input signal or a control signal of an internal control circuit.

(Step S102)

The IR drop analyzing section 8 carries out the IR drop analysis to determine the IR drop analysis result 9 when the functional block selected at the step S101 operates independently or individually, that is, when the other functional blocks are not subjected to the IR drop analysis and are in an operation stop state. The IR drop analyzing section 8 receives the power supply RC network analysis result 5, the functional block operation rate data 6 and the input clock data 7, and outputs the IR drop analysis result 9 when the selected functional block on the semiconductor device operates independently or individually.

(Step S103)

The mapping value generating section 10 receives the IR drop analysis result 9 and outputs the distribution of individual mapping values 11 for the selected functional block.

The IR drop analysis result 9 is obtained through a simulation of the IR drop analysis and shows a continuous distribution of IR drop quantity on the semiconductor device, as a function of coordinate position (x, y). The resolution at this time depends on a precision of the simulation in the IR drop analysis. On the other hand, the IR drop analysis result 9 of high resolution is redundant in case of grouping processing of the simultaneously operable functional blocks. For example, when it is sufficient that the IR drop analysis result 9 shows an IR drop value for every 10 m in one of two directions, the IR drop quantity for every 0.1 m is redundant. The excess redundancy increases the load of the design supporting apparatus 20 and influences the processing speed of the design supporting apparatus 20. Therefore, as the resolution of the IR drop quantity, the resolution which is determined based on the circuit scale in the functional block is sufficient. In the present embodiment, this resolution is expressed by small areas in a lattice. The size of the small area in the lattice is determined based on the minimum of the areas of the functional blocks on the semiconductor device. That is, the size of the small area is determined such that the IR drop quantity in the functional block having the minimum area can be effectively used. The individual mapping value 11 in the present embodiment is related to one IR drop quantity in each of the small areas.

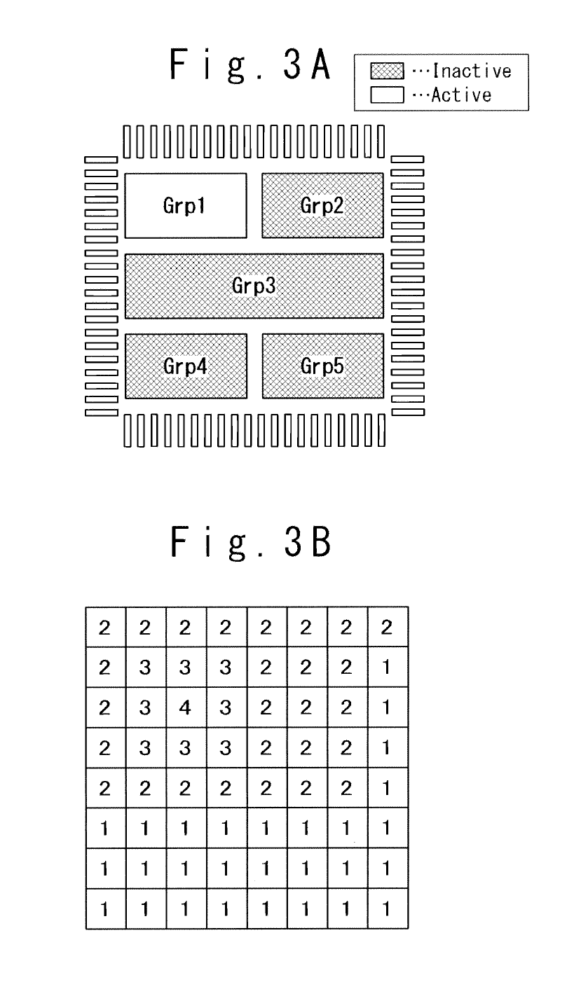

FIG. 3A is a diagram showing functional blocks Grp1 to Grp5 existing on the semiconductor device, and the functional block Grp1 operating independently or individually. FIG. 3B is a diagram showing a distribution of individual mapping values 11 determined from the IR drop analysis result 9 when the functional block Grp1 operates independently or individually as shown in FIG. 3A. The distribution of individual mapping values 11 in FIG. 3B correspond to a distribution of IR drop quantities when a voltage obtained by subtracting the minimum operation guarantee voltage of the functional block from the voltage of an external power supply is set to be “10”. When the individual mapping value is larger, the IR drop quantity in the small area is larger. Because the semiconductor device malfunctions when any of the individual mapping values 11 is equal to or more than “10”, the permission value 13 is set to “9”.

In this example, the mapping value generating section 10 calculates a distribution of individual mapping values 11 based on a ratio of an actual IR drop quantity and the voltage obtained by subtracting the minimum operation guarantee voltage of the functional block from the voltage of the external power supply. In this way, the individual mapping values can be manipulated for integration, even in case where a plurality of functional blocks different in minimum operation guarantee voltage exist on the semiconductor device, and the simultaneously operable functional blocks can be grouped.

(Step S104)

When the IR drop analyzing section 8 carries out the IR drop analysis on each of the functional blocks on the semiconductor device while operating it independently or individually, the control flow advances to the processing at step S105, and otherwise, returns to the processing at the step S101.

(Step S105)

The grouping section 12 initializes the number n of simultaneously operable functional blocks to “0”.

(Step S106)

The grouping section 12 increments the number n of simultaneously operable functional blocks by one.

(Step S107)

When the number n of simultaneously operable functional blocks is more than the number N of functional blocks on the semiconductor device, the grouping section 12 ends the processing, and when the number n is equal to or less than the number N, the control flow advances to step S108.

(Step S108)

When the n functional blocks are operable simultaneously, the grouping section 17 outputs one of the combinations of the n simultaneously operable functional blocks as combination data 17. The number of combinations of the functional blocks when the n functional blocks of the N function blocks operate simultaneously is calculated from _{N}Cₙ.

(Step S109)

The grouping section 17 receives the combination data 17 and the distributions of individual mapping values 11, and calculates a distribution of group mapping values 11 of the n simultaneously operating functional blocks according to the combination data 17 outputted at the step S108. The grouping section 17 calculates the group mapping value 11 for each small area by adding the individual mapping values 11 mapped onto the small area.

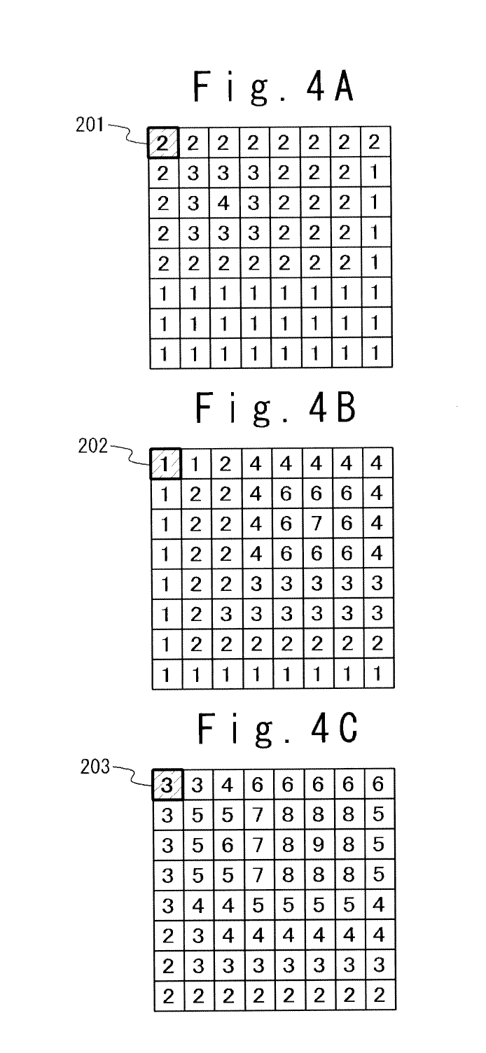

FIG. 4A, FIG. 4B and FIG. 4C are diagrams showing a method of calculating the group mapping values 11 of two simultaneously operating functional blocks in the design supporting apparatus 20 of the present embodiment. FIG. 4A is a distribution of the individual mapping values 11 when the function block Grp1 operates independently. FIG. 4B is a distribution of individual mapping values 11 when the function block Grp2 operates independently. FIG. 4C is a distribution of group mapping values when the function block Grp1 and the function block Grp2 operate simultaneously. FIG. 4C shows that the group mapping values of the two simultaneously operating function blocks is calculated by adding the individual mapping values in FIG. 4A and the individual mapping values in FIG. 4B with respect to the small areas, respectively.

For example, it is supposed that the position of one of the small areas in the lattice is expressed by X on a horizontal axis and Y on the vertical axis. Supposing that the individual mapping value for each of the small areas is Z, the individual mapping value can be expressed as (X, Y, Z). In such an expression, the individual mapping value 11 corresponding to the small area 201 is (1, 8, 2) in FIG. 4A. The mapping value corresponding to the small area 202 is (1, 8, 1) in FIG. 4B. The group mapping value corresponding to the small area 203 is (1, 8, 2)+(1, 8, 1)=(1, 8, 3) in FIG. 4C.

(Step S110)

If a group mapping value of the n simultaneously operating function blocks in each small area is equal to or less than the permission value 13, the control flow advances to the processing at step S112. When the group mapping value is larger than the permission value 13, the control flow advances to step S111.

(Step S111)

When a malfunction determination is carried out for all the combinations when the n function blocks are operable simultaneously, the control flow advances to the processing at the step S106, and otherwise, the control flow advances to the processing at the step S108.

When it is determined to be “yes” at the step S106, because the group data are obtained, the automatic test pattern generating section generates a test pattern based on the group data to test the simultaneously operable functional blocks.

(Step S112)

The grouping section 17 outputs the group data 14 indicative of a group of functional blocks which are determined not to malfunction at the step S110 even if operating simultaneously, and then the control flow advances to the processing at the step S111.

In the above method, t is possible to determine the group data indicative of a group of the simultaneously operating functional blocks, by adding the individual mapping values 11 of the simultaneously operating functional blocks to generate the group mapping values, and comparing the group mapping values and the permission value 13.

### Second Embodiment

In a second embodiment, by repeating a subtraction of the individual mapping value 11 from the group mapping value when the simultaneously operating functional blocks malfunction, a group of the functional blocks which do not malfunction even if operating simultaneously is determined, unlike to the method of the first embodiment.

(Configuration)

Because the configuration of the design supporting apparatus 20 of the present embodiment is same as that of the design supporting apparatus 20 of the first embodiment, the description is omitted.

(Operation)

The test supporting method by the design supporting apparatus 20 in the second embodiment will be described. The test supporting method of the present embodiment is same as that of the first embodiment, except that the group data 14 indicative of the simultaneously operable functional blocks is determined by repeating a subtraction of the individual mapping value 11. Therefore, a method of determining the group data 14 in the present embodiment is hereinafter described using a specific example.

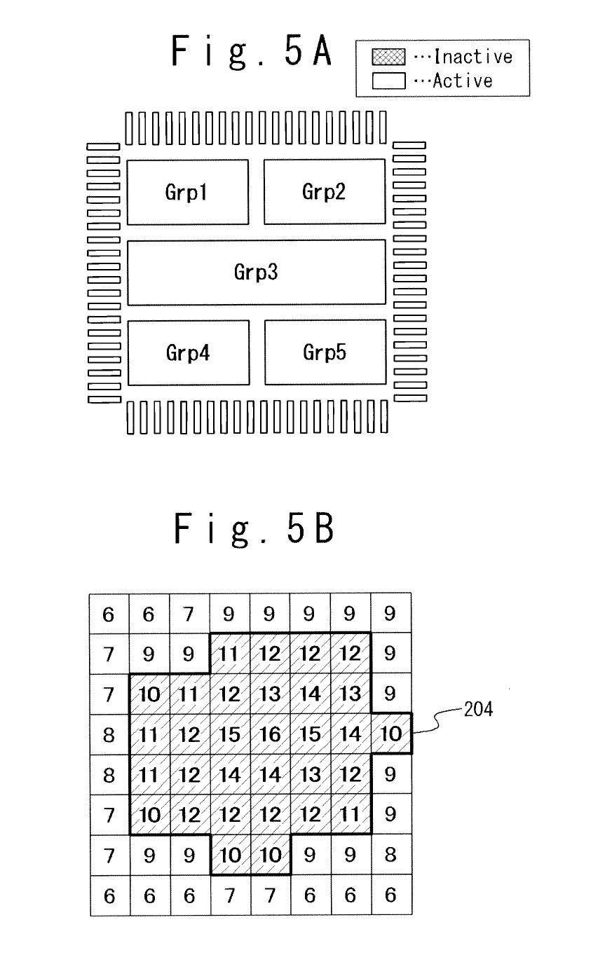

FIG. 5A is a diagram showing the five functional blocks Grp1 to Grp5 existing on the semiconductor device. FIG. 5B is a diagram showing that a distribution of group mapping values of the five simultaneously operating functional blocks is partially larger than the permission value 13. Because the group mapping values in an area 204 are larger than “9” of the permission value 13, the grouping section 17 determines the semiconductor device to malfunction.

By reducing one of the simultaneously operating functional blocks, the grouping section 17 determines whether or not the group mapping value is equal to or less than “9” of the permission value 13 in all the small areas.

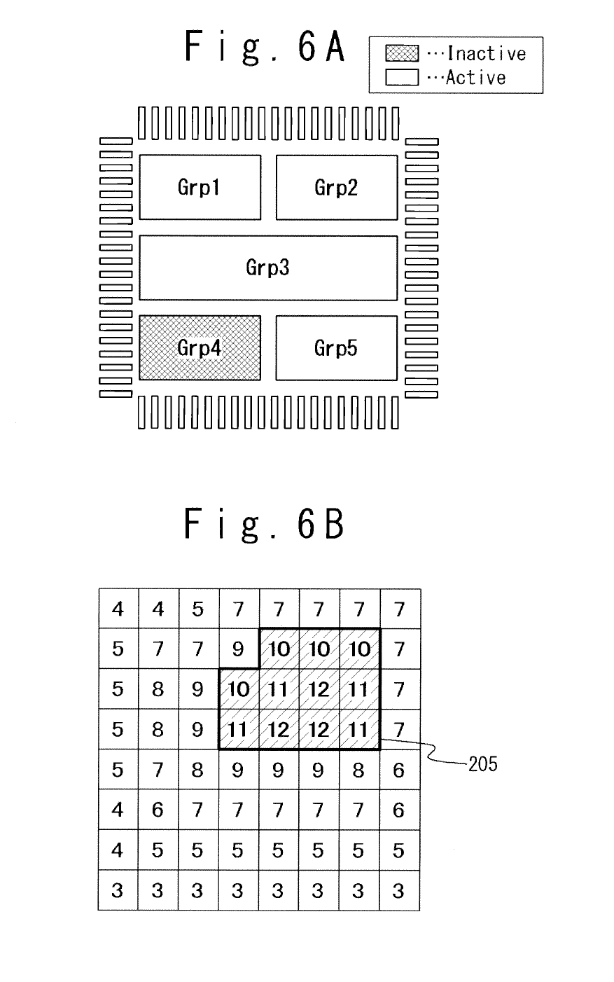

FIG. 6A is a diagram showing that the five functional blocks Grp1 to Grp5 existing on the semiconductor device operate simultaneously other than the functional block Grp4. FIG. 6B is a diagram showing that the mapping values of the four simultaneously operating functional blocks in an area 205 are larger than the permission value 13. Because the group mapping values in an area 205 are larger than “9” of the permission value 13, the grouping section 17 determines that the semiconductor device malfunctions.

Moreover, by reducing one of the simultaneously operating functional blocks, the grouping section 17 determines whether or not the group mapping values 11 are all equal to or less than “9” of the permission value 13 in all the small areas.

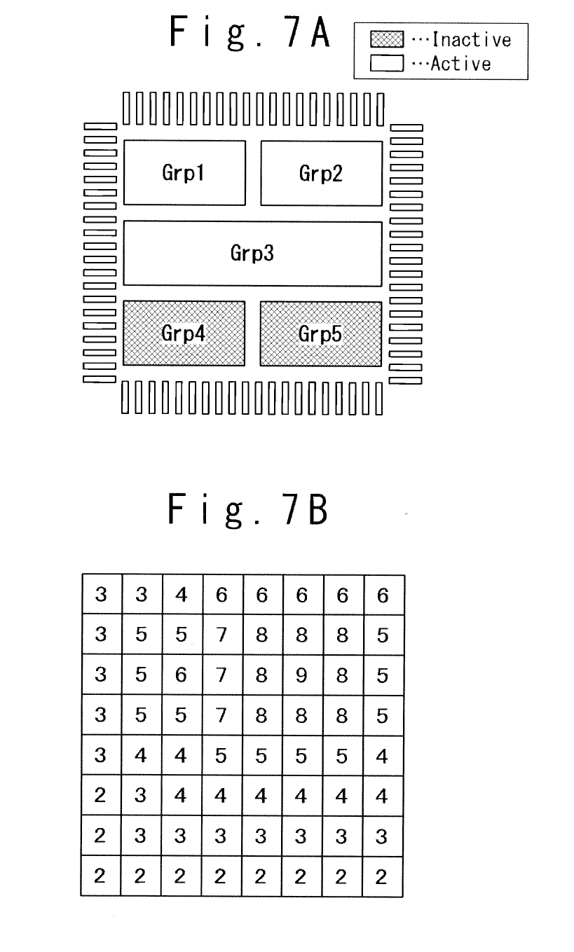

FIG. 7A is a diagram showing the functional blocks Grp1 to Grp5 existing on the semiconductor device and the functional blocks Grp1 to Grp3 operating simultaneously. FIG. 7B is a diagram showing that the group mapping values of the three simultaneously operating functional blocks are within the permission value 13. Because the group mapping values are equal to or less than “9” of the permission value 13 in all the small areas in the lattice, the grouping section 17 determines that the semiconductor device does not malfunction, and stores the functional blocks Grp1 to Grp3 as the group data 14.

In the above subtracting method, the functional blocks are stopped one by one and the individual mapping values 11 corresponding to the stopped functional block are subtracted from the remaining group mapping values. At this time, when the individual mapping values of two or more functional blocks to be stopped operate are already known, the known individual mapping values may be subtracted once.

By generating a test pattern 16 based on the group data 14 obtained in the first and second embodiments and carrying out a test, the design supporting apparatus for the semiconductor device can be provided not to malfunction even if the functional blocks on the semiconductor device operate simultaneously in a wider area than in an actual operation.

Also, supposing that the number of the functional blocks on the semiconductor device is N, the number of combinations of the simultaneously operable functional blocks is (2^{N}−1). Therefore, conventionally, the IR drop analysis needs to be carried out (2^{N}−1) times. However, in the first and second embodiments, because the IR drop analysis needs to be carried out only N times where each of the functional blocks operates independently or individually, the design TAT by the design supporting apparatus can be reduced.

Also, the first and second embodiments may be applied after the above design phase of the semiconductor device is ended and the semiconductor device is actually manufactured and assembled. In this case, the first and second embodiments are applied to actual results of the IR drop analysis when a test pattern file divided for every functional block division run on the semiconductor device. The test pattern file divided for every functional block is a scan test pattern file or a test pattern file of a functional block such as SRAM (Static Random Access Memory) and a hard macro. If the respective test pattern files can run logically correctly at a same time, the test pattern files can be executed simultaneously in the first and second embodiments. Therefore, the time required to execute all the test pattern files can be reduced and the test time can be shortened.

Also, when BIST (built-in self-test) is built in the semiconductor device, a test pattern for BIST can be generated based on the group data 14 generated in the first and second embodiments so that the functional blocks can be tested simultaneously. Therefore, the test time can be shortened even in the test using BIST.

Above, the embodiments of the present invention have been described. However, the present invention is not limited to the above embodiments and can be appropriately modified by a skilled person in the art.

What is claimed is:

1. A design supporting apparatus for a semiconductor device, comprising:
an IR drop analyzing section configured to carry out an IR drop analysis on each of N (2 N) functional blocks, which operates independently on a semiconductor device, to generate an IR drop analysis result;
wherein an area of the semiconductor device is divided into small areas in a lattice;
a mapping value generating section configured to calculate a distribution of individual mapping values related to the small areas from said IR drop analysis result for said each function block; and
a grouping section configured to calculate a distribution of group mapping values from said distributions of individual mapping values for n (n≦N) simultaneously operating functional blocks of said N functional blocks, and output group data indicative of said n simultaneously operating functional blocks when each of the group mapping values falls within a permission value.

2. The design supporting apparatus according to claim 1, wherein said mapping value generating section determines a size of each of the small areas based on the minimum of areas of said N functional blocks on the semiconductor device.

3. The design supporting apparatus according to claim 1, wherein said mapping value generating section determines the maximum of an IR drop quantity in each of the small areas from said IR drop analysis result as the individual mapping value for the small area.

4. The design supporting apparatus according to claim 1, wherein said mapping value generating section calculates the individual mapping value from the following equation:
(the maximum IR drop quantity in the small area)/((external power supply voltage)−(minimum operation guarantee voltage of said functional block containing the small area))

5. The design supporting apparatus according to claim 1, wherein said grouping section calculates said distribution of group mapping values by adding said individual mapping values of said distributions of said n simultaneously operating functional blocks for every small area.

6. The design supporting apparatus according to claim 1, wherein said grouping section calculates said distribution of group mapping values from said distributions of individual mapping values for said n simultaneously operating functional blocks, subtracts said individual mapping values for said small areas of each of said n simultaneously operating functional blocks from said group mapping values until each of the group mapping values after the subtraction falls within the permission value, when each of the group mapping values does not fall within a permission value.

7. A design supporting method, executed by a computer, for a semiconductor device, comprising:
carrying out an IR drop analysis on each of N (2 N) functional blocks, which operates independently on a semiconductor device, to generate an IR drop analysis result;
wherein an area of the semiconductor device is divided into small areas in a lattice;
calculating a distribution of individual mapping values related to the small areas from said IR drop analysis result for said each function block;
calculating a distribution of group mapping values from said distributions of individual mapping values for n (n≦N) simultaneously operating functional blocks of said N functional blocks; and
generating group data indicative of said n simultaneously operating functional blocks when each of the group mapping values falls within a permission value.

8. The design supporting method according to claim 7, wherein said calculating a distribution of individual mapping values comprises:
determining a size of each of the small areas based on the minimum of areas of said N functional blocks on the semiconductor device.

9. The design supporting method according to claim 7, wherein said calculating a distribution of individual mapping values comprises:
determining the maximum of an IR drop quantity in each of the small areas from said IR drop analysis result as the individual mapping value for the small area.

10. The design supporting method according to claim 7, wherein said calculating a distribution of individual mapping values comprises:
calculating the individual mapping value from the following equation:
(the maximum IR drop quantity in the small area)/((external power supply voltage)−(minimum operation guarantee voltage of said functional block containing the small area))

11. The design supporting method according to claim 7, wherein said calculating a distribution of group mapping values comprises:
calculating said distribution of group mapping values by adding said individual mapping values of said distributions of said n simultaneously operating functional blocks for every small area.

12. The design supporting method according to claim 7, wherein said calculating a distribution of group mapping values comprises:
calculating said distribution of group mapping values from said distributions of individual mapping values for said n simultaneously operating functional blocks; and
subtracting said individual mapping values for said small areas of each of said n simultaneously operating functional blocks from said group mapping values until each of the group mapping values after the subtraction falls within the permission value, when each of the group mapping values does not fall within a permission value.

13. A non-transitory computer-readable storage medium which stores a computer-executable program code to attain a design supporting method for a semiconductor device,
wherein said design supporting method comprises:
carrying out an IR drop analysis on each of N (2 N) functional blocks, which operates independently on a semiconductor device, to generate an IR drop analysis result;
wherein an area of the semiconductor device is divided into small areas in a lattice;
calculating a distribution of individual mapping values related to the small areas from said IR drop analysis result for said each function block;
calculating a distribution of group mapping values from said distributions of individual mapping values for n (n≦N) simultaneously operating functional blocks of said N functional blocks; and
generating group data indicative of said n simultaneously operating functional blocks when each of the group mapping values falls within a permission value.

14. The non-transitory computer-readable storage medium according to claim 13, wherein said calculating a distribution of individual mapping values comprises:
determining a size of each of the small areas based on the minimum of areas of said N functional blocks on the semiconductor device.

15. The non-transitory computer-readable storage medium according to claim 13, wherein said calculating a distribution of individual mapping values comprises:
determining the maximum of an IR drop quantity in each of the small areas from said IR drop analysis result as the individual mapping value for the small area.

16. The non-transitory computer-readable storage medium according to claim 13, wherein said calculating a distribution of individual mapping values comprises:
calculating the individual mapping value from the following equation:
(the maximum IR drop quantity in the small area)/((external power supply voltage)−(minimum operation guarantee voltage of said functional block containing the small area))

17. The non-transitory computer-readable storage medium according to claim 13, wherein said calculating a distribution of group mapping values comprises:
calculating said distribution of group mapping values by adding said individual mapping values of said distributions of said n simultaneously operating functional blocks for every small area.

18. The non-transitory computer-readable storage medium according to claim 13, wherein said calculating a distribution of group mapping values comprises:
calculating said distribution of group mapping values from said distributions of individual mapping values for said n simultaneously operating functional blocks; and
subtracting said individual mapping values for said small areas of each of said n simultaneously operating functional blocks from said group mapping values until each of the group mapping values after the subtraction falls within the permission value, when each of the group mapping values does not fall within a permission value.
